(19) United States
(12) Patent Application Publication
(10) Pub. No.: US 2004/0215937 A1
(43) Pub. Date: Oct. 28, 2004

(54) Dynamically share interrupt handling logic among multiple threads

(75) Inventors: William E. Burky, Austin, TX (US); Susan E. Eisen, Austin, TX (US); Hung Q. Le, Austin, TX (US); David A. Schroter, Round Rock, TX (US)

Correspondence Address: Robert A. Voigt, Jr., 5400 Renaissance Tower, 1201 Elm Street, Dallas, TX, 75270, US

(73) Assignee: International Business Machines Corporation, Armonk, NY (US)

(21) Appl. No.: 10/422,020

(22) Filed: Apr. 23, 2003

(51) Int. Cl. G06F 9/30

(52) U.S. Cl. 712/218

(57) ABSTRACT

A method and multithreaded processor for dynamically sharing an interrupt handling logic unit among multiple threads. A first and second state unit may be configured to determine whether an interrupt was generated from a first thread and a second thread, respectively. An arbiter may be coupled to the first and second state units. A shared interrupt handling logic unit may be coupled to the arbiter where the shared interrupt handling logic unit may be configured to handle interrupts generated from the first and second threads. Upon a state unit, e.g., first state unit, second state unit, determining an interrupt was generated from a particular thread, the state unit may request control of the interrupt handling logic unit from the arbiter. The arbiter may grant the request from the state unit if the interrupt handling logic unit is available to handle the interrupt detected.

### TECHNICAL FIELD

The present invention relates to the field of multithreading processors, and more particularly to a mechanism for dynamically sharing interrupt handling logic among multiple threads.

### BACKGROUND INFORMATION

Modern processors employed in computer systems use various techniques to improve their performance. One of these techniques is commonly referred to as “multithreading.” Multithreading allows multiple streams of instructions, commonly referred to as “threads,” to be executed. The threads may be independent programs or related execution streams of a single parallel program or both.

Processors may support three types of multithreading. The first is commonly referred to as “coarse-grained” or “block multithreading.” Coarse-grained or block multithreading may refer to rapid switching of threads on long-latency operations. The second is commonly referred to as “fine-grained multithreading.” Fine-grained multithreading may refer to rapid switching of the threads on a cycle-by-cycle basis. The third type of multithreading is commonly referred to as “simultaneous multithreading.” Simultaneous multithreading may refer to scheduling of instructions from multiple threads within a single cycle.

An interrupt may refer to a signal that gets the attention of the processor. One type of interrupt may be referred to as a “program flow interrupt” where an interrupt interrupts the sequence of instructions being executed by the program. For example, a return from interrupt instruction may redirect the program flow to another address, e.g., an address of the instruction following the instruction that caused the interrupt. In another example, an instruction may be to divide by zero. Upon dividing by zero, a hardware fault may occur thereby generating an interrupt to be handled by an interrupt handling logic unit. The interrupt handling logic unit may handle the hardware fault by redirecting the program flow to an address indicated by the interrupt (a pointer). This address may be the start of an interrupt handling routine to handle the fault. Upon completion of the interrupt handling routine, the program flow may return to executing the instruction following the fault. Another type of interrupt may be referred to as an “asynchronous interrupt” which is generated independent of the program flow. For example, an interrupt may be generated by an internal timer that may continually interrupt the processor several times per second to keep the time of day current or for timesharing purposes. As with program flow interrupts, upon the issuance of an asynchronous interrupt, an interrupt handling logic unit may handle the interrupt.

In a simultaneous multithreading processor, there are dedicated interrupt handling logic units to handle interrupts, e.g., program flow interrupts, asynchronous interrupts, generated for each thread. That is, there are n dedicated interrupt handling logic units to handle interrupts generated for n threads. Having a dedicated interrupt handling logic unit for each thread can be expensive in terms of die area and logic.

Therefore, there is a need in the art to dynamically share a single interrupt handling logic unit among multiple threads.

### SUMMARY

The problems outlined above may at least in part be solved in some embodiments by having multiple state machines where each state machine may be configured to determine whether an interrupt was generated from a particular thread. Upon a state machine determining an interrupt was generated from a particular thread, the state machine may request control of a single interrupt handling logic unit from an arbiter. The arbiter may grant the request from the state machine if the interrupt handling logic unit is available to handle the interrupt detected.

In one embodiment of the present invention, a unit may comprise a first state unit configured to determine whether an interrupt was generated from a first thread. The unit may further comprise a second state unit configured to determine whether an interrupt was generated from a second thread. The unit may further comprise an arbiter coupled to the first and second state units. The unit may further comprise a shared interrupt handling logic unit coupled to the arbiter where the shared interrupt handling logic unit may be configured to handle interrupts generated from the first and second threads. The arbiter may be configured to determine ownership of the shared interrupt handling logic unit among the first and second state units.

The foregoing has outlined rather broadly the features and technical advantages of one or more embodiments of the present invention in order that the detailed description of the invention that follows may be better understood. Additional features and advantages of the invention will be described hereinafter which form the subject of the claims of the invention.

### BRIEF DESCRIPTION OF THE DRAWINGS

A better understanding of the present invention can be obtained when the following detailed description is considered in conjunction with the following drawings, in which:

FIG. 1 illustrates an embodiment of the present invention of a computer system;

FIG. 2 illustrates an embodiment of the present invention of a simultaneous multithreading processor;

FIG. 3 is an embodiment of the present invention of a completion unit; and

FIG. 4 is a flowchart of a method for dynamically sharing an interrupt handling logic unit among multiple threads in accordance with an embodiment of the present invention.

### DETAILED DESCRIPTION

The present invention comprises a method and multithreaded processor for dynamically sharing an interrupt handling logic unit among multiple threads. In one embodiment of the present invention, a unit may include a first state unit configured to determine whether an interrupt was generated from a first thread. The unit may further include a second state unit configured to determine whether an interrupt was generated from a second thread. The unit may further include an arbiter coupled to the first and second state units. The unit may further include a shared interrupt handling logic unit coupled to the arbiter where the shared interrupt handling logic unit may be configured to handle interrupts generated from the first and second threads. Upon a state unit, e.g., first state unit, second state unit, determining an interrupt was generated from a particular thread, the state unit may request control of the interrupt handling logic unit from the arbiter. The arbiter may grant the request from the state unit if the interrupt handling logic unit is available to handle the interrupt detected.

Although the present invention is described with reference to sharing an interrupt handling logic unit among two threads, it is noted that the principles of the present invention may be applied to sharing the interrupt handling logic unit among any number of threads. It is further noted that a person of ordinary skill in the art would be capable of applying the principles of the present invention as discussed herein to sharing the interrupt handling logic unit among any number of threads. It is further noted that embodiments applying the principles of the present invention discussed herein to sharing the interrupt handling logic unit among any number of threads would fall within the scope of the present invention.

It is further noted that although the present invention is described with reference to a simultaneous multithreading processor, the principles of the present invention may be applied to any type of multithreading processor including other types of multithreading, e.g., course grained, fine-grained multithreading. It is further noted that a person of ordinary skill in the art would be capable of applying the principles of the present invention as discussed herein to any type of multithreading processor. It is further noted that embodiments applying the principles of the present invention discussed herein to any type of multithreading processor would fall within the scope of the present invention.

In the following description, numerous specific details are set forth to provide a thorough understanding of the present invention. However, it will be apparent to those skilled in the art that the present invention may be practiced without such specific details. In other instances, well-known circuits may be shown in block diagram form in order not to obscure the present invention in unnecessary detail. For the most part, details considering timing, data formats within communication protocols, and the like have been admitted inasmuch as such details are not necessary to obtain a complete understanding of the present invention and are within the skills of persons of ordinary skill in the relevant art.

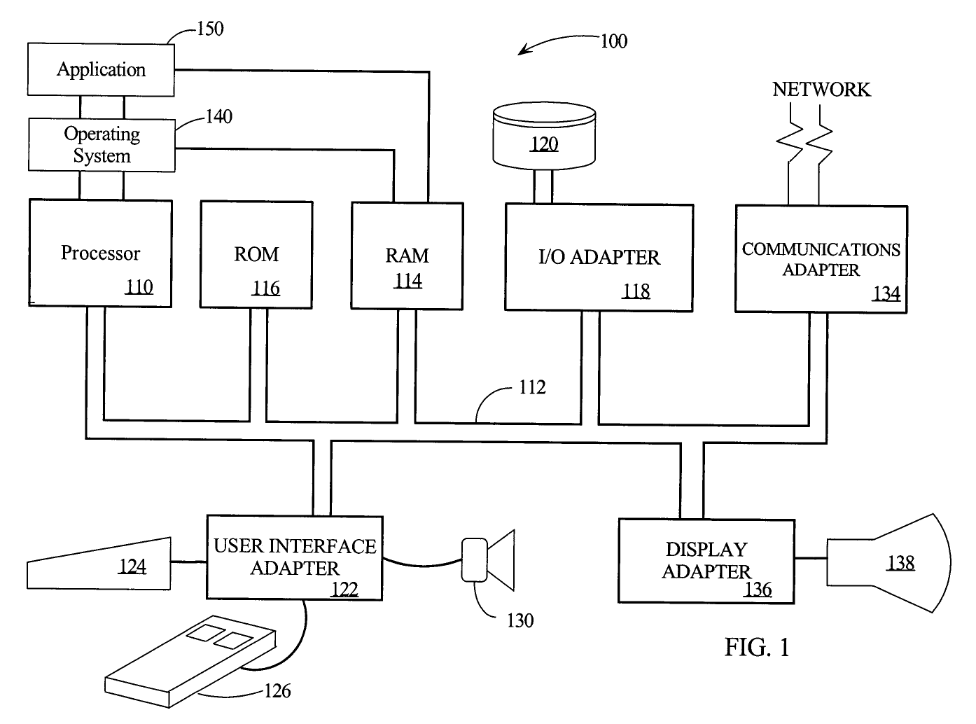

FIG. 1—Computer System

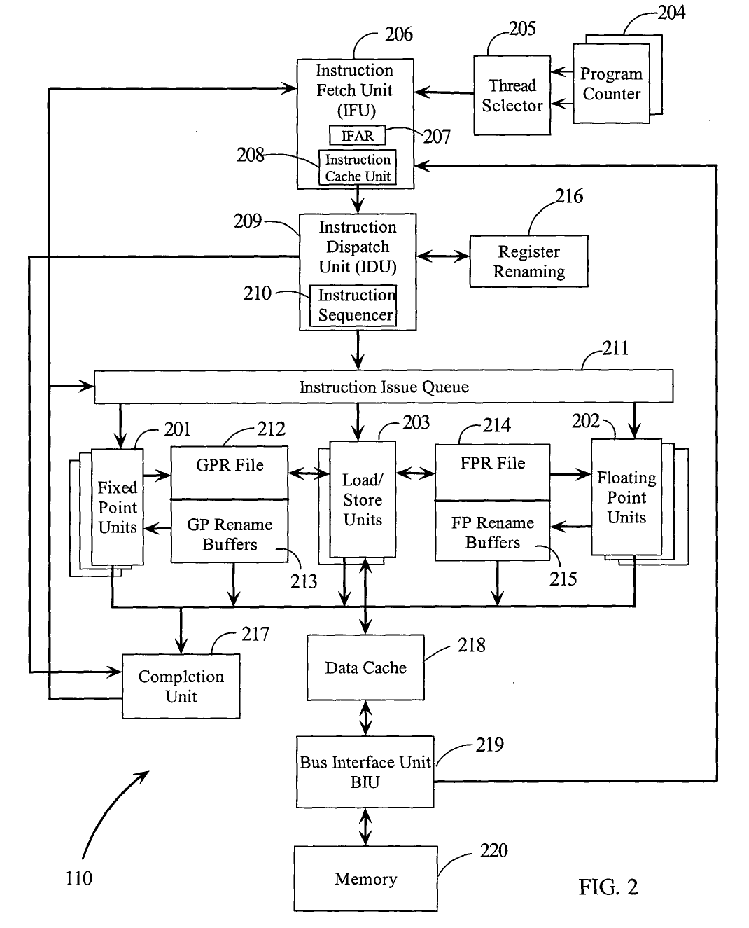

FIG. 1 illustrates a typical hardware configuration of computer system 100 which is representative of a hardware environment for practicing the present invention. Computer system 100 may have a processing unit 110 coupled to various other components by system bus 112. Processing unit 110 may be a simultaneous multithreading processor as described in detail below in conjunction with FIG. 2. An operating system 140 may run on processor 110 and provide control and coordinate the functions of the various components of FIG. 1. An application 150 in accordance with the principles of the present invention may run in conjunction with operating system 140 and provide calls to operating system 140 where the calls implement the various functions or services to be performed by application 150. Read-Only Memory (ROM) 116 may be coupled to system bus 112 and include a basic input/output system (“BIOS”) that controls certain basic functions of computer system 100. Random access memory (RAM) 114 and disk adapter 118 may also be coupled to system bus 112. It should be noted that software components including operating system 140 and application 150 may be loaded into RAM 114 which may be computer system's 100 main memory for execution. Disk adapter 118 may be an integrated drive electronics (“IDE”) adapter that communicates with a disk unit 120, e.g., disk drive.

Referring to FIG. 1, computer system 100 may further comprise a communications adapter 134 coupled to bus 112. Communications adapter 134 may interconnect bus 112 with an outside network enabling computer system 100 to communicate with other such systems. I/O devices may also be connected to system bus 112 via a user interface adapter 122 and a display adapter 136. Keyboard 124, mouse 126 and speaker 130 may all be interconnected to bus 112 through user interface adapter 122. Event data may be inputted to computer system 100 through any of these devices. A display monitor 138 may be connected to system bus 112 by display adapter 136. In this manner, a user is capable of inputting to computer system 100 through keyboard 124 or mouse 126 and receiving output from computer system 100 via display 138.

FIG. 2—Simultaneous Multithreading Processor

FIG. 2 illustrates an embodiment of a simultaneous multithreading processor 110. Multithreading processor 110 may be configured to execute multiple instructions per clock cycle. Further, processor 110 may be configured to simultaneous execute instructions from multiple threads as discussed further below. These instructions may be executed in any of the execution units of processor 110 including Fixed Point Units (FXUs) 201, Floating Point Units (FPUs) 202 and Load/Store Units (LSUs) 203 during any one clock cycle. It is noted that processor 110 may comprise other execution units, such as branch execution units, and that processor 110 is not limited in scope to any one particular embodiment. It is further noted that processor 110 may include additional units, registers, buffers, memories, and other sections than illustrated in FIG. 2. It is further noted that some of the elements described below such as issue queues 211, FXUs 201, FPUs 202, LSUs 203, may be referred to either collectively or individually, e.g., FXUs 201, FXU 201. It is further noted that although processor 110 is described below as executing instructions from two threads that processor 110 may be configured to execute instructions from any number of threads.

Referring to FIG. 2, processor 110 may comprise Program Counters (PCs) 204 that correspond to multiple threads, e.g., thread one, thread two, that have instructions for execution. A thread selector 205 may toggle on each clock cycle to select which thread to be executed. Upon selection of a particular thread, an Instruction Fetch Unit (IFU) 206 may be configured to load the address of an instruction from PCs 204 into Instruction Fetch Address Register 207. The address received from PCs 204 may be an effective address representing an address from the program or compiler. The instruction corresponding to the received effective address may be accessed from Instruction Cache (I-Cache) unit 208 comprising an instruction cache (not shown) and a prefetch buffer (not shown). The instruction cache and prefetch buffer may both be configured to store instructions. Instructions may be inputted to instruction cache and prefetch buffer from a system memory 220 through a Bus Interface Unit (BIU) 219.

Instructions from I-Cache unit 208 may be outputted to Instruction Dispatch Unit (IDU) 209. IDU 209 may be configured to decode these received instructions. At this stage, the received instructions are primarily alternating from one thread to another. IDU 209 may further comprise an instruction sequencer 210 configured to forward the decoded instructions in an order determined by various algorithms. The out-of-order instructions may be forwarded to one of a plurality of issue queues 211 where a particular issue 211 may be coupled to one or more particular execution units, fixed point units 201, load/store units 203 and floating point units 202. Each execution unit may execute one or more instructions of a particular class of instructions. For example, FXUs 201 may execute fixed point mathematical and logic operations on source operands, such as adding, subtracting, ANDing, ORing and XORing. FPUs 202 may execute floating point operations on source operands, such as floating point multiplication and division. FXUs 201 may input their source and operand information from General Purpose Register (GPR) file 212 and output their results (destination operand information) of their operations for storage at selected entries in General Purpose rename buffers 213. Similarly, FPUs 202 may input their source and operand information from Floating Point Register (FPR) file 214 and output their results (destination operand information) of their operations for storage at selected entries in Floating Point (FP) rename buffers 215.

Processor 110 may dynamically share processor resources, such as execution units, among multiple threads by renaming and mapping unused registers to be available for executing an instruction. This may be accomplished by register renaming unit 216 coupled to IDU 209. Register renaming unit 216 may be configured to determine the registers from the register file, e.g., GPR file 212, FPR file 214, that will be used for temporarily storing values indicated in the instructions decoded by IDU 209.

As stated above, instructions may be queued in one of a plurality of issue queues 211. If an instruction contains a fixed point operation, then that instruction may be issued by an issue queue 211 to any of the multiple FXUs 201 to execute that instruction. Further, if an instruction contains a floating point operation, then that instruction may be issued by an issue queue 211 to any of the multiple FPUs 202 to execute that instruction.

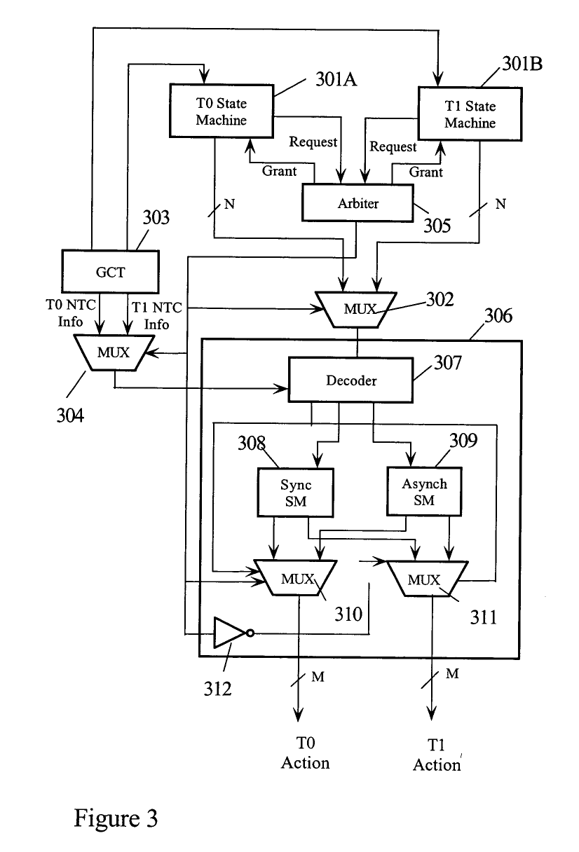

All of the execution units, FXUs 201, FPUs 202, LSUs 203, may be coupled to completion unit 217. Upon executing the received instruction, the execution units, FXUs 201, FPUs 202, LSUs 203, may transmit an indication to completion unit 217 indicating the execution of the received instruction. This information may be stored in a table (not shown) which may then be forwarded to IFU 206. Completion unit 217 may further be coupled to IDU 209. IDU 209 may be configured to transmit to completion unit 217 the status information, e.g., type of instruction, associated thread, address, of the instructions being dispatched to issue queues 211. Completion unit 217 may further be configured to track the status of these instructions. For example, completion unit 217 may keep track of when these instructions have been “completed.” An instruction may be said to be “completed” when it has executed and is at a stage where any exception will not cause the re-issuance of this instruction. In one embodiment, completion unit 217 may track the status of when a group of instructions per thread, e.g., thread T₀, thread T₁, becomes completed. This information may be stored in a table, referred to herein as the “Group Completion Table (GCT).” A more detailed description of GCT is provided further below in conjunction with FIG. 3. Completion unit 217 may further be coupled to issue queues 211 and further configured to transmit an indication of an instruction being completed to the appropriate issue queue 211 that issued the instruction that was completed. Completion unit 217 may further be configured to detect and handle interrupts as discussed further below in conjunction with FIG. 3.

LSUs 203 may be coupled to a data cache 218. In response to a load instruction, LSU 203 inputs information from data cache 218 and copies such information to selected ones of rename buffers 213, 215. If such information is not stored in data cache 218, then data cache 218 inputs through Bus Interface Unit (BIU) 219 such information from a system memory 220 connected to system bus 112 (FIG. 1). Moreover, data cache 218 may be able to output through BIU 219 and system bus 112 information from data cache 218 to system memory 220 connected to system bus 112. In response to a store instruction, LSU 203 may input information from a selected one of GPR 212 and FPR 214 and copies such information to data cache 218.

It is noted that processor 110 may comprise any number of execution units, e.g., FXUs 201, FPUs 202, LSUs 203, any number of issue queues 211, program counters 201 representing threads, GPRs 212 and FPRs 214, and that processor 110 is not to be confined in scope to any one particular embodiment.

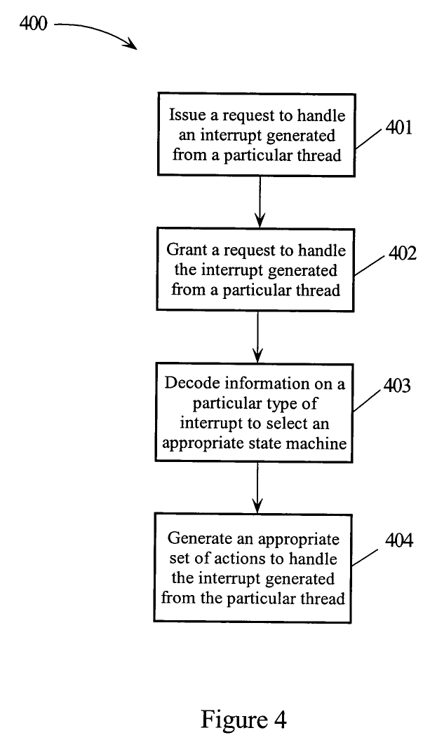

As stated in the Background Information section, in a simultaneous multithreading processor, there are dedicated interrupt handling logic units to handle interrupts generated for each thread. That is, there are n dedicated interrupt handling logic units to handle interrupts generated for n threads. Having a dedicated interrupt handling logic unit for each thread can be expensive in terms of die area and logic. Therefore, there is a need in the art to dynamically share a single interrupt handling logic unit among multiple threads. A single interrupt handling logic unit within completion unit 217 may be dynamically shared among multiple threads as described below in conjunction with FIG. 3. A method for dynamically sharing a single interrupt handling logic unit among multiple threads using the configuration of completion unit 217 described herein is discussed further below in conjunction with FIG. 4.

FIG. 3—Completion Unit

FIG. 3 illustrates an embodiment of the present invention of completion unit 217 (FIG. 2) configured to dynamically share a single interrupt handling logic unit within completion unit 217 among multiple threads.

Referring to FIG. 3, completion unit 217 may comprise state machines 301A-B configured to determine whether processor 110 (FIG. 2) receives an interrupt generated from thread T₀, thread T₁, respectively. State machines 301A-B may collectively or individually be referred to as state machines 301 or state machine 301, respectively. In one embodiment, state machine 301A may determine if either a program flow interrupt or an asynchronous interrupt was generated from thread T₀. Similarly, state machine 301B may determine if either a program flow interrupt or an asynchronous interrupt was generated from thread T₁. In one embodiment, state machine 301 may be configured to detect and store information, e.g., the type of asynchronous interrupt, regarding an asynchronous interrupt generated from the appropriate thread. For example, state machine 301A may be configured to detect and store information regarding an asynchronous interrupt generated from thread T₀. Similarly, machine 301B may be configured to detect and store information regarding an asynchronous interrupt generated from thread T₁. In one embodiment, state machines 301 may comprise logic configured to receive an indication of an asynchronous interrupt from the unit (software or hardware), e.g., internal timer, generating the asynchronous interrupt. The outputs of state machines 301A-B (N bits of data regarding the detected asynchronous interrupt) are inputted to multiplexer 302 configured to select either the information regarding an asynchronous interrupt generated from either thread T₀ or thread T₁ when there is an asynchronous interrupt as discussed further below.

Completion unit 217 may further comprise GCT 303 configured to detect a program flow interrupt per thread, e.g., threads T₀,T₁. Upon detecting a program flow interrupt, GCT 303 may be configured to transmit an indication of detecting a program flow interrupt to the appropriate state machine 301. For example, upon GCT 303 detecting a program flow interrupt generated from thread T₀, GCT 303 may transmit an indication of detecting a program flow interrupt generated from thread T₀ to state machine 301A. Similarly, upon GCT 303 detecting a program flow interrupt generated from thread T₁, GCT 303 may transmit an indication of detecting a program flow interrupt generated from thread T₁ to state machine 301B. In one embodiment, GCT 303 may receive an indication of a program flow interrupt from an execution unit, e.g., fixed point units 201, floating point units 202, load/store units 203, upon the execution unit executing an instruction causing a hardware fault. GCT 303 may further be configured to store information such as the next to complete instruction for the thread that generated the interrupt. As stated above, an instruction may be said to be “completed” when it has executed and is at a stage where any exception will not cause the re-issuance of this instruction. The “next to complete instruction” is the instruction following the completed instruction with the highest priority to be executed. Other information stored by GCT 303 may include the type of program flow interrupt generated from a particular thread. The outputs of GCT 303 are inputted to multiplexer 304 configured to select either the information regarding a program flow interrupt generated from either thread T₀ or thread T₁ when there is a program flow interrupt as discussed further below.

Completion unit 217 may further comprise an arbiter 305 coupled to state machines 301. Arbiter 305 may further be coupled to the select line in multiplexers 302, 304. Upon state machine 301 detecting an interrupt (program flow interrupt from GCT 303 or asynchronous interrupt), the respective state machine 301 may transmit a request to arbiter 305 to obtain control of interrupt handling logic unit 306 to handle the detected interrupt. Interrupt handling logic unit 306 may be coupled to multiplexer 302, 304. If both state machines 301A-B concurrently transmit a request to arbiter 305 to obtain control of interrupt handling logic unit 306, arbiter 305 is configured to grant control to one of the state machines 301A-B based on an arbitration algorithm. It is noted that arbiter 305 may be configured to implement any type of arbitration algorithm, e.g., round robin, and that such algorithms are known to persons of ordinary skill in the art. It is further noted that such algorithms would fall within the scope of the present invention.

Upon receiving a request from state machine 301 to obtain control of interrupt handling logic unit 306, arbiter 305 may be configured to grant the request when interrupt handling logic unit 306 is available to handle the interrupt. In one embodiment, if interrupt handling logic unit 306 is not available to handle the interrupt, arbiter 305 may be configured to transmit a response to state machine 301 to reissue the request at a later time. In another embodiment, if interrupt handling logic unit 306 is not available to handle the interrupt, arbiter 305 may be configured to store the incoming request in a queue until arbiter 305 is able to grant the request when interrupt handling logic unit 306 is available to handle the interrupt.

In one embodiment, if arbiter 305 receives multiple requests to obtain control of interrupt handling logic unit 306 concurrently, arbiter 305 may be configured to grant one of the requests if interrupt handling logic unit 306 is available to handle the interrupt and transmit a response to the other state machine 301 to reissue the request at a later time. In another embodiment, if arbiter 305 receives multiple requests to obtain control of interrupt handling logic unit 306 concurrently, arbiter 305 may be configured to grant one of the requests if interrupt handling logic unit 306 is available to handle the interrupt and may be configured to store the other incoming request in a queue until arbiter 305 is able to grant that request when interrupt handling logic unit 306 is available to handle the interrupt.

Upon arbiter 305 granting the request to obtain control of interrupt handling logic unit 306, arbiter 305 may output the appropriate signal to multiplexer 302, 304 in order for the appropriate multiplexer 302, 304 to select the appropriate information to be provided to interrupt handling logic unit 306. For example, if arbiter 305 granted state machine's 301 A request to obtain control of interrupt handling logic unit 306 upon detecting an asynchronous interrupt from thread T₀, then multiplexer 302 may select the information, e.g., the type of asynchronous interrupt, provided by state machine 301A regarding the detected asynchronous interrupt from thread T₀ upon receiving the appropriate signal from arbiter 305. If arbiter 305 granted state machine's 301B request to obtain control of interrupt handling logic unit 306 upon detecting an asynchronous interrupt from thread T₁, then multiplexer 302 may select the information, e.g., the type of asynchronous interrupt, provided by state machine 301B regarding the detected asynchronous interrupt from thread T₁ upon receiving the appropriate signal from arbiter 305. If, for example, arbiter 305 granted state machine's 301A request to obtain control of interrupt handling logic unit 306 upon receiving an indication from GCT 303 of detecting a program flow interrupt generated from thread T₀, then multiplexer 304 may select the information, e.g., the type of synchronous interrupt, the next to complete instruction for thread T₀, provided by GCT 303 regarding the detected synchronous interrupt from thread T₀ upon receiving the appropriate signal from arbiter 305. If arbiter 305 granted state machine's 301B request to obtain control of interrupt handling logic unit 306 upon receiving an indication from GCT 303 of detecting a program flow interrupt generated from thread T₁, then multiplexer 304 may select the information, e.g., the type of program flow interrupt, the next to complete instruction for thread T₀, provided by GCT 303 regarding the detected synchronous interrupt from thread T₁ upon receiving the appropriate signal from arbiter 305.

As stated above, multiplexers 302, 304 may be coupled to interrupt handling logic unit 306. Interrupt handling logic unit 306 may comprise a decoder 307 coupled to a synchronous interrupt state machine 308 and an asynchronous interrupt state machine 309. Decoder 307 may be configured to receive and decode the information outputted by multiplexers 302, 304 upon arbiter 305 granting a request from either state machine 301A or 301B. As discussed above, information regarding a program flow interrupt may be provided by multiplexer 304 and the information regarding an asynchronous interrupt may be provided by multiplexer 302. Decoder 307 may be configured to determine the type of interrupt detected, e.g., program flow interrupt, asynchronous interrupt, based on the received information from multiplexers 302, 304. That is, decoder 307 may determine the type of interrupt detected by decoding the information provided by multiplexers 302, 304.

As stated above, decoder 307 may be coupled to synchronous interrupt state machine 308 and asynchronous interrupt state machine 309. Synchronous interrupt state machine 308 is configured to generate a set of actions, as described below, to handle program flow interrupts. Asynchronous interrupt state machine 309 is configured to generate a set of actions, e.g., as described below, to handle asynchronous interrupts. For example, if decoder 307 received information regarding a program flow interrupt from multiplexer 304, then decoder 307 may transmit that information to synchronous interrupt state machine 308 in order for synchronous interrupt state machine 308 to generate the appropriate set of actions to handle the detected program flow interrupt. If decoder 307 received information regarding an asynchronous interrupt from multiplexer 302, then decoder 307 may transmit that information to asynchronous interrupt state machine 309 to generate the appropriate set of actions to handle the detected asynchronous interrupt.

As stated above, synchronous interrupt state machine 308 and asynchronous interrupt state machine 309 may be configured to generate a set of actions to handle program flow interrupts and asynchronous interrupts, respectively, generated from threads T₀, T₁. For example, bits in a register may be set to indicate the cause of the interrupt. A register may be loaded with an address of the instruction to be executed following the execution of the handling routine. The current state of processor 110 (FIG. 2) at the time of the interrupt may be loaded in a register. The address of the routine to handle the interrupt may be generated. Instructions subsequent to the next to complete instruction may be flushed.

These specific set of actions may be directed to the thread, e.g., thread T₀, thread T₁, which generated the interrupt via M bits of data from synchronous interrupt state machine 308, asynchronous interrupt state machine 309.

Interrupt handling logic unit 306 may further comprise multiplexers 310, 311 configured to output the appropriate set of actions applied to threads T₀, T₁, respectively. The output of synchronous interrupt state machine 308, asynchronous interrupt state machine 309 may be inputted to multiplexers 310, 311. The output of arbiter 305 may be inputted to the enable line of multiplexer 310. The inversion of the output of arbiter 305 may be inputted to the enable line of multiplexer 311. Further, the decoder 307 may output a signal to the select lines of multiplexers 310, 311.

Multiplexer 310 may output the set of actions to handle either the program flow interrupt or asynchronous interrupt generated from thread T₀ . Similarly, multiplexer 311 may output the set of actions to handle either the program flow interrupt or asynchronous interrupt generated from thread T₁. Multiplexers 311, 312 may output the set of actions to handle either the program flow interrupt or asynchronous interrupt generated from the appropriate thread based on the signals from arbiter 305, decoder 307. For example, if a program flow interrupt was generated from thread T₀, then multiplexer 310 may output the set of actions to handle the particular program flow interrupt generated from thread T₀ in response to the signal from arbiter 305 enabling multiplexer 310 and in response to the signal from decoder 307 selecting the set of actions generated from synchronous interrupt state machine 308. If a program flow interrupt was generated from thread T₀, multiplexer 311 would be disabled by the inversion of the signal from arbiter 305. If an asynchronous interrupt was generated from thread T₀, then multiplexer 310 may output the set of actions to handle the asynchronous interrupt generated from thread T₀ in response to the signal from arbiter 305 enabling multiplexer 310 and in response to the signal from decoder 307 selecting the set of actions generated from asynchronous interrupt state machine 309. If an asynchronous interrupt was generated from thread T₀, multiplexer 311 would be disabled by the inversion of the signal from arbiter 305. Similarly, if a program flow interrupt was generated from thread T₁, then multiplexer 311 may output the set of actions to handle the particular program flow interrupt generated from thread T₁ in response to the signal from arbiter 305 enabling multiplexer 311 and in response to the signal from decoder 307 selecting the set of actions generated from synchronous interrupt state machine 308. If a program flow interrupt was generated from thread T₁, multiplexer 310 would be disabled by the inversion of the signal from arbiter 305. If an asynchronous interrupt was generated from thread T₁, then multiplexer 311 may output the set of actions to handle the asynchronous interrupt generated from thread T₁ in response to the signal from arbiter 305 enabling multiplexer 311 and in response to the signal from decoder 307 selecting the set of actions generated from asynchronous interrupt state machine 309. If an asynchronous interrupt was generated from thread T₁, multiplexer 310 would be disabled by the inversion of the signal from arbiter 305.

It is noted that the circuitry of completion unit 217 described above is illustrative and that other circuitry may be used to accomplish the functions described above. It is further noted that embodiments incorporating such other circuitry would fall within the scope of the present invention.

A description of a method for dynamically sharing a single interrupt handling logic unit 306 among multiple threads using the configuration of completion unit 217 described above is discussed below in conjunction with FIG. 4.

FIG. 4—Method for Dynamically Sharing an Interrupt Handling Logic Unit Among Multiple Threads

FIG. 4 is a flowchart of one embodiment of the present invention of a method 400 for dynamically sharing interrupt handling logic unit 306 (FIG. 3) among multiple threads.

Referring to FIG. 4, in conjunction with FIG. 3, in step 401, state machine 301 issues a request to arbiter 305 to obtain control of interrupt handling logic unit 306 to handle an interrupt generated from a particular thread, e.g., thread T₀. For example, state machine 301A may issue a request to arbiter 305 to obtain control of interrupt handling logic unit 306 to handle an interrupt, e.g., program flow interrupt, asynchronous interrupt, generated from thread T₀. Similarly, state machine 301B may issue a request to arbiter 305 to obtain control of interrupt handling logic unit 306 to handle an interrupt, e.g., program flow interrupt, asynchronous interrupt, generated from thread T₁.

In step 402, arbiter 305 grants the request issued by state machine 301 when handling logic unit 306 is available to handle the interrupt requested by state machine 301. As stated above, in one embodiment, if interrupt handling logic unit 306 is not available to handle the interrupt, arbiter 305 may transmit a response to state machine 301 to reissue the request at a later time. In another embodiment, if interrupt handling logic unit 306 is not available to handle the interrupt, arbiter 305 may store the incoming request in a queue until arbiter 305 is able to grant the request when interrupt handling logic unit 306 is available to handle the interrupt. Further, in one embodiment, if arbiter 305 receives multiple requests to obtain control of interrupt handling logic unit 306 concurrently, arbiter 305 may grant one of the requests if interrupt handling logic unit 306 is available to handle the interrupt and transmit a response to the other state machine 301 to reissue the request at a later time. In another embodiment, if arbiter 305 receives multiple requests to obtain control of interrupt handling logic unit 306 concurrently, arbiter 305 may grant one of the requests if interrupt handling logic unit 306 is available to handle the interrupt and may store the other incoming request in a queue until arbiter 305 is able to grant that request when interrupt handling logic unit 306 is available to handle the interrupt.

In step 403, decoder 307 decodes the information on a particular type of interrupt received from multiplexer 302, 304 to select the appropriate state machine, e.g., synchronous interrupt state machine 308, asynchronous interrupt state machine 309. As stated above, decoder 307 may be configured to receive and decode the information outputted by multiplexers 302, 304 upon arbiter 305 granting a request from either state machine 301A or 301B. Information regarding a program flow interrupt may be provided by multiplexer 304 and the information regarding an asynchronous interrupt may be provided by multiplexer 302. Decoder 307 may select the appropriate state machine, e.g., synchronous interrupt state machine 308, asynchronous interrupt state machine 309, based on the received information from multiplexers 302, 304.

In step 404, the selected state machine, e.g., synchronous interrupt state machine 308, asynchronous interrupt state machine 309, in step 403, generates the appropriate set of actions to handle the interrupt generated from the particular thread, e.g., thread T₀.

It is noted that method 400 may include other and/or additional steps that, for clarity, are not depicted. It is noted that method 400 may be executed in a different order presented and that the order presented in the discussion of FIG. 4 is illustrative. It is further noted that certain steps in method 400 may be executed in a substantially simultaneous manner.

Although the method and multithreaded processor are described in connection with several embodiments, it is not intended to be limited to the specific forms set forth herein, but on the contrary, it is intended to cover such alternatives, modifications and equivalents, as can be reasonably included within the spirit and scope of the invention as defined by the appended claims. It is noted that the headings are used only for organizational purposes and not meant to limit the scope of the description or claims.

1. A multithreaded processor including a completion unit coupled to a plurality of queues, wherein said completion unit is configured to receive status information on dispatched decoded instructions to said plurality of queues, wherein said completion unit comprises:
a first state unit configured to determine whether an interrupt was generated from said first thread;
a second state unit configured to determine whether an interrupt was generated from said second thread;
an arbiter coupled to said first and said second state units; and
a shared interrupt handling logic unit coupled to said arbiter, wherein said shared interrupt handling logic unit is configured to handle interrupts generated from said first and said second threads, wherein said arbiter is configured to determine ownership of said shared interrupt handling logic unit among said first and said second state units.

2. The multithreaded processor as recited in claim 1, wherein said first and said second state units are configured to issue requests to said arbiter to obtain ownership of said shared interrupt handling logic unit upon generation of an interrupt from said first and said second threads, respectively.

3. The multithreaded processor as recited in claim 2, wherein said arbiter is configured to grant a request issued from one of said first and said second state units.

4. The multithreaded processor as recited in claim 3, wherein said granting said request from one of said first and said second state units results in ownership of said shared interrupt handling logic unit for one of said first and said second threads.

5. The multithreaded processor as recited in claim 2, wherein said first and said second state units are further configured to transmit information on asynchronous interrupts to said shared interrupt handling logic unit.

6. The multithreaded processor as recited in claim 1, wherein said completion unit further comprises:
a table coupled to said shared interrupt handling logic unit, wherein said table is configured to store information on program flow interrupts for each of said first and said second threads.

7. The multithreaded processor as recited in claim 6, wherein said table is further configured to transmit an indication of a program flow interrupt for one of said first and said second threads to one of said first and said second state units.

8. The multithreaded processor as recited in claim 6, wherein said table is further configured to transmit information on a next to complete instruction to said shared interrupt handling logic unit.

9. The multithreaded processor as recited in claim 1, wherein said shared interrupt handling logic unit comprises:
a decoder;
a synchronous interrupt state machine coupled to said decoder, wherein said synchronous interrupt state machine is configured to generate a set of actions to handle program flow interrupts; and
an asynchronous interrupt state machine coupled to said decoder, wherein said asynchronous interrupt state machine is configured to generate a set of actions to handle asynchronous interrupts;
wherein said decoder is configured to determine which type of interrupt is generated from one of said first thread and said second threads.

10. The multithreaded processor as recited in claim 9, wherein said decoder is further configured to select one of said synchronous interrupt state machine and said asynchronous interrupt state machines to generate an appropriate set of actions to handle said type of interrupt determined for one of said first thread and said second threads.

11. An apparatus, comprising:
a first state unit configured to determine whether an interrupt was generated from a first thread;
a second state unit configured to determine whether an interrupt was generated from a second thread;
an arbiter coupled to said first and said second state units; and
a shared interrupt handling logic unit coupled to said arbiter, wherein said shared interrupt handling logic unit is configured to handle interrupts generated from said first and said second threads, wherein said arbiter is configured to determine ownership of said shared interrupt handling logic unit among said first and said second state units.

12. The apparatus as recited in claim 11, wherein said first and said second state units are configured to issue requests to said arbiter to obtain ownership of said shared interrupt handling logic unit upon generation of an interrupt from said first and said second threads, respectively.

13. The apparatus as recited in claim 12, wherein said arbiter is configured to grant a request issued from one of said first and said second state units.

14. The apparatus as recited in claim 13, wherein said granting said request from one of said first and said second state units results in ownership of said shared interrupt handling logic unit for one of said first and said second threads.

15. The apparatus as recited in claim 12, wherein said first and said second state units are further configured to transmit information on asynchronous interrupts to said shared interrupt handling logic unit.

16. The apparatus as recited in claim 11 further comprising:
a table coupled to said shared interrupt handling logic unit, wherein said table is configured to store information on program flow interrupts for each of said first and said second threads.

17. The apparatus as recited in claim 16, wherein said table is further configured to transmit an indication of a program flow interrupt for one of said first and said second threads to one of said first and said second state units.

18. The apparatus as recited in claim 16, wherein said table is further configured to transmit information on a next to complete instruction to said shared interrupt handling logic unit.

19. The apparatus as recited in claim 11, wherein said shared interrupt handling logic unit comprises:
a decoder;
a synchronous interrupt state machine coupled to said decoder, wherein said synchronous interrupt state machine is configured to generate a set of actions to handle program flow interrupts; and
an asynchronous interrupt state machine coupled to said decoder, wherein said asynchronous interrupt state machine is configured to generate a set of actions to handle asynchronous interrupts;
wherein said decoder is configured to determine which type of interrupt is generated from one of said first thread and said second threads.

20. The apparatus as recited in claim 19, wherein said decoder is further configured to select one of said synchronous interrupt state machine and said asynchronous interrupt state machines to generate an appropriate set of actions to handle said type of interrupt determined for one of said first thread and said second threads.

21. A method for dynamically sharing an interrupt handling logic unit among multiple threads comprising the steps of:
issuing a request to handle an interrupt associated with a particular thread;
granting said request to handle said interrupt associated with said particular thread;
decoding information on a type of said interrupt to select an appropriate state machine; and
generating an appropriate set of actions to handle said interrupt associated with said particular thread by said selected state machine.
